(19) United States
(12) Patent Application Publication
(10) Pub. No.: US 2022/0273125 A1
(43) Pub. Date: Sep. 1, 2022

(54) FOLDING SPOON, METHOD AND APPARATUS FOR MANUFACTURING SUCH FOLDING SPOON

(71) Applicant: Schur Pack Denmark A/S, Horsens (DK)

(72) Inventors: Holger Tabermann, Ry (DK); Bjarne Helbo Sørensen, Tranbjerg J (DK)

(21) Appl. No.: 17/634,231

(22) PCT Filed: Aug. 12, 2019
(86) PCT No.: PCT/DK2019/050241

§ 371 Date: Feb. 9, 2022

(51) Int. Cl. A47G 21/04; B26F 1/44; B31D 5/04

(52) U.S. Cl. CPC A47G 21/04; B26F 1/44; B31D 5/04; B26F 2001/4418

(57) ABSTRACT

Various embodiments of the present disclosure are directed to a folding spoon apparatus and a method of manufacturing a folding spoon. In one example embodiment, a folding spoon is disclosed including a planar blank and a plurality of scores disposed on said planar blank. The planar blank has along a longitudinal axis a handle portion with a front lateral edge and a bowl portion with a rear lateral edge. The plurality of scores including a longitudinal handle folding line extending from said front lateral edge, along said longitudinal axis, towards a rear lateral edge opposite said front lateral edge and terminating in the bowl portion, or two longitudinal handle folding lines provided on said planar blank symmetrically in relation to the longitudinal axis. The handle portion includes a first lateral folding line, and a cut out forming a retainer flap.

### FIELD OF THE INVENTION

The present invention relates to a folding spoon, comprising:

a planar blank having a front end and rear end foldable along fold lines and score lines to form a spoon comprising a handle portion connected to a bowl portion, wherein the planar blank includes a front lateral edge of the planar blank and a longitudinal axis dividing said planar blank into two general symmetrical halves, and

a plurality of scores disposed on said planar blank including a longitudinal handle score extending from said front lateral edge along said longitudinal axis towards a rear lateral edge opposite said front lateral edge and terminating in the bowl port.

Furthermore, the invention relates to a method for manufacturing such folding spoon in a folded state, which method comprises the step of punching and embossing a sheet for establishing a number of said planar blanks.

Furthermore, the invention relates to an apparatus for manufacturing such folding spoon in a folded state, which apparatus comprises a punching station for punching and embossing the planer blanks out from a sheet.

### BACKGROUND OF THE INVENTION

It is known to provide disposable cutleries for use with takeaway food or “food on the go” allowing a user to eat the food whilst not in a location where conventional cutleries are available and/or allowing a user to easily dispose of all the packaging and the cutleries after the food has been consumed.

Examples of conventional disposable cutlery are plastic knives, forks and spoons.

However, there are problems with the plastic cutlery in that it is relatively expensive to produce. Moreover, it is not biodegradable and therefore it is not environmentally friendly.

The cutlery is often provided loose in a box, where a user may select the cutlery in a retail outlet or restaurant. This may be connected with hygienic problems.

Cutlery attached to a container in which the food product is provided is also known.

In general, the containers have the shape of a cylinder or truncated cylinder, and the diameter thereof would often be less than the length of the cutlery. Therefore it is also known to provide foldable cutlery, like spoons and forks, in order to maintain the cutlery in the container instead of having the cutlery provided in loose condition in a separate box.

Foldable cutlery is often difficult to provide when manufacturing plastic cutlery.

Cutlery made from a blank of paper which is cut or stamped from paper sheet or cardboard sheet is not provided with an integral mechanism for retaining the cutlery in folded condition. Often separate clamping elements are used for maintaining the folded condition during storage. However, such separate items are time consuming to apply.

Known cutlery, like forks and spoons, often causes problems due to sharp edges at the bowl portion making them uncomfortable for the user when the sharp edges contact the lips during use.

However, a bowl needs to have a cavity form making it able to contain liquid products like yogurt. Such cavity form is not necessary in connection with forks.

In order to provide such folding spoons, a complex structure of fold and score lines are often used to form the spoon.

When folding the cutlery it would be beneficial to have this done automatically, preferably in connection with the manufacturing of the planar blanks for the folding cutlery.

There is a desire to provide such automatic method and apparatus in order to lower the costs for providing the folded cutlery in large volume making it possible to meet the increasing demand for disposable cutlery.

Conventional folding spoons have usability or manufacturability issues that do not scale when making thousands of units per minute. The market conditions for the disposable single use spoon requires that such quantity should be produced in a competitive way irrespective that these disposable spoons may be certified to meet standards for composability and consumer concerns and thus are environmentally friendlier than plastic spoons.

Manufacturing techniques are known which uses a sheet-feed-process known from the printing industry. Such process includes a number of steps for transforming a large roll of paper stock or a large amount of separate sheets from a mill into a bundle of foldable spoons. However, up until now there is no solution to provide the spoons in a folded condition from such process equipment.

With the known techniques a bland/blend or blanks are provided with different steps including sheets into individual sheets feeding the sheets into a stop-and-go-process for possible blending of the product and a die-stamping-process that cuts out individual planar blanks. The stamping process could be combined with a process for establishing fold and score lines. After this, a gathering and packaging of the individual products are established. If the produced planar blanks should be delivered in a folded condition, this would require a separate handling which would often be associated with time-consuming and costly manual handling.

Accordingly, there is a need for a folding spoon and a system including method and apparatus for the manufacture of such folding spoon automatically making it possible to provide customers with a spoon in a folded condition.

Moreover, the need also requires that a foldable spoon is technically simple in order to make it easy for the user to use the folding spoon without specific instructions.

The present invention is primarily directed to a foldable spoon, however the bowl portion of the spoon may be provided with slits extending from the rear lateral edge and thereby the eating cutlery would have a form which is more like a fork. However, in the present invention the term “spoon” is used to cover both types of cutleries, and accordingly it will comprise a bowl portion with or without slits.

In the present invention, folding lines and scores would be used more or less as synonyms. In the following, only score is mentioned, however this expression will also cover folding lines.

### Object of the Invention

Accordingly, it is the object of the present invention to provide folding cutlery, preferably folding spoons, which overcome the above-mentioned problems.

It is a further object of the invention to provide a method and an apparatus which makes it possible to manufacture such folding cutlery in a folded condition automatically.

### Description of the Invention

This object is obtained with a spoon mentioned by way of introduction and being peculiar in that a first lateral score is arranged in said handle portion in a position closer to said rear lateral edge than to said front lateral edge and extending transversal to said longitudinal axis, that a second lateral score is arranged in said handle portion in a distance from said first lateral score corresponding to the distance between said first lateral score and said rear lateral edge and extending transversal to said longitudinal axis and that a cut out extends from said second lateral score toward said rear lateral edge and back to said second lateral score and thereby forms a retainer flap arranged to be placed behind an edge area at said rear lateral edge when the spoon is in folded condition, being folded along said first lateral score.

When folding the spoon around the first lateral score, the lateral edge will be provided along the second lateral score. Seeing that the retainer flap is provided, it is easy to fold the spoon around the second lateral score, thereby placing the retainer flap behind the edge area at the lateral edge. Hereby the edge area would be retained in a position between the retainer flap and the edge area of the handle portion adjacent to the second lateral score.

Hereby the spoon is retained in a folded position for storage and transport. It is easy for the user to fold the handle portion around the second lateral score and be able to unfold the spoon. After unfolding the spoon, it will be provided again as a substantially planar blank.

Then the user may apply a compression force on the two sides of the handle portion. This is simply done when the user holds the spoon in his hand for use. When applying the force on the side edges on the handle, a folding occurs along the longitudinal handle score. Hereby a V-form is established which provides a strong and sturdy and functional spoon.

Side edges of the bowl portion together with side edges of the handle portion will constitute the limitation of the planar blank and be connected with the rear and front lateral edges of the planar blank. Thereby the planar blank is defined.

The method according to the invention is peculiar in that it further comprises the steps of:
punching and embossing a sheet for establishing a number of said planar blanks which are arranged side by side and are connected through a first retaining strip and a second retaining strip at the front lateral edge and the rear lateral edge,
transferring said punched sheet to a conveyor,
conveying, in the conveyor, the punched sheet in a state being pinched in a transport plane between upper and lower pinching means to a first cutting station,
cutting off, in the first cutting station, the first retaining strip thereby leaving the planar blank only connected through the second retaining strip,
conveying, in the conveyor, the connected planar blank in the pinched state to a folding station while removing the first retaining strip,
folding, in the folding station, the planar blank along said first lateral score while pinching a part of the planar blank, thereby bringing the handle portion and the bowl portion in superimposed position being squeezed against each other in the transport plane,
folding, in the folding station, the superimposed portions of the now folded blank along the second lateral score thereby the retainer flap in the transport plane as the edge area between the second lateral score and the front lateral edge,
folding, in the folding station, portion of the superimposed portions of the now folded blank along the second lateral score back to the transport plane and thereby placing the retainer flap behind the edge area at said rear lateral edge when the spoon is in folded condition,
conveying, in the conveyor, the spoon in folded and retained state to a second cutting station,
cutting off, in the second cutting station, the second retaining strip, thereby providing folded spoons in the folded and retained state.

The apparatus according to the invention is peculiar in that said apparatus further comprises at least one cutting station for cutting the planar blanks free from retaining strips connecting the planar blanks, a conveyor for conveying the planar blanks through the different stations and a folding station for folding the planar blanks into folded spoons in the folded and retained state.

The method and the apparatus provide a system which makes it possible to manufacture the folding spoon and ensure that it is in a retained state after leaving the apparatus.

As the planar blanks, after being punched and embossed, are still connected through the retaining strips at the front and lateral edge of the planar blanks, it is possible to guide the product into the apparatus. The sheet may be provided as a roll or be provided as a stock of separate sheets.

When guiding the punched sheet in the conveyor in a pinched state, it is possible to guide the product through the cutting and folding stations in a secure and controlled way.

Cutting off the first retaining strips in the first cutting stations makes it possible to establish a first folding where each spoon individually is folded around the first lateral score. The blanks will still be connected by the second retaining strips also after they have changed from the planar form to the folded state.

After the first folding to the superimposed position, the blank will have the retainer flap in the plane of the handle.

The second folding, which is a folding around the second lateral score, will fold the superimposed handle portion and the bowl portion, while the retainer flap attached to the handle portion closest to the second retaining strip will be maintained in the transport plane. Hereby the retainer flap will be positioned behind the edge area at said rear lateral edge.

Thereafter, when effecting the third folding of the bowl portion and the handle portion back to the transport plane; the retainer flap will be placed behind the edge area of the handle portion which is adjacent to the second lateral score when folding around the second lateral score.

Hereby the bowl portion is retained against the handle portion.

The first folding may be effected through an angle of 180° to bring the bowl portion and the handle portion in a superimposed state.

The second folding may be effected through an angle sufficient to bring the retainer flap free of the edge area at said rear lateral edge. Such angle may be between 45° and 90° .

The angle of the third folding corresponds to the angle of the second folding.

The further conveying of the spoon in folded condition is easy to effect in a controlled way as the number of spoons arranged side by side are still connected through the second retaining strip.

After cutting off the second retaining strip in the second cutting stations, the folded spoons will be free and can be collected in a bin. Alternatively, the folded individual spoons may be collected in following equipment which may include packaging equipment for providing the folded individual spoon in a packing if it is desired to deliver the folded spoons in individual packings.

The system comprising the method and the apparatus may work at production speeds known from printing equipment. Accordingly, it is possible to produce thousands of units per minute. Hereby it is possible to meet market conditions for disposable single use spoons.

As folded spoons are made of paper stock, they will meet the requirement for environmentally friendly products at low unit costs.

As it appears from the above, the folded spoon may be obtained without any manual handling of the product and without any clips or other equipment for retaining the spoon in a folded stage during transport and storage.

According to a further embodiment, the spoon is peculiar in that said longitudinal handle score terminates at a vertex and that a pair of bowl scores each extends from said vertex towards said rear lateral edge on opposing sides of said longitudinal axis

At the vertex, the force applied will also cause a folding of the bowl portion close to the handle portion. Hereby side part of the bowl portion will be folded out of the plane containing the longitudinal handle score. This will create a bowl portion having a hollowed form which can be used to maintain a liquid product.

The bowl scores extend only over a first part of the bowl portion which is arranged closest to the handle portion.

The outermost part of the bowl, where no bowl scores are provided, will remain in a planar condition. Hereby the bowl portion will be very convenient for a user to put into his mouth. No sharp side edges of the bowl portion will come into contact with the user's lips. Hereby, the product becomes surprisingly user friendly and simultaneously it will have the ability to maintain liquid products in the part of the bowl portion closest to the handle portion.

As the bowl scores extend only over a first part of the bowl portion which is arranged closest to the handle portion, the outermost portion of the bowl portion will not be provided with scores.

It is preferred that the bowl scores under an angle between 20° and 40° to each side of the longitudinal axis.

According to an embodiment, the bowl scores are linear scores. However, alternatively the bowl scores may be curved.

In an embodiment, the bowl scores extend over half of the extension of the bowl portion.

It is preferred to provide only one longitudinal handle score which coincides with the longitudinal axis.

Alternatively, it is possible to have two longitudinal handle scores extending along the longitudinal axis and being parallel to said longitudinal axis and arranged on each side of the longitudinal axis. When having two longitudinal handle scores, each longitudinal handle score will end in a point corresponding to the vertex, however from this point, only one bowl score will extend towards the rear lateral edge with a direction away from said longitudinal axis.

The bowl scores extending from a longitudinal handle score will extend from the longitudinal handle score to a side edge of the bowl portion.

According to a further embodiment, the spoon is peculiar in that said cut out comprises two cut out parts being arranged symmetrical in relation to the longitudinal axis.

The two cut out parts could be arranged to form one single retainer flap which has a V-form when the two cut out parts are linear and arranged under a symmetric angle and joining each other at the longitudinal axis.

Alternatively, the two cut out parts may be curved and form a U-formed retainer flap.

Other forms are possible.

It is also possible to establish two cut out parts which are provided from the second lateral score and extending outwardly at end at the side edge of the handle portion. Hereby, a retainer flap is arranged at each side edge of the handle.

Accordingly, it is possible to have one or more retainer flaps arranged to be placed behind the edge area at the rear lateral edge when the spoon is in folded condition.

According to a further embodiment, the spoon is peculiar in that said handle portion has a width which is smaller than the width of the bowl portion and that the bowl portion is connected to the handle portion via a connecting portion having double curvatured side edges connecting outer side edges of the handle portion and the bowl portion.

When double curvatured side edges are used to connect the outer side edges of the handle portion and the bowl portion, it has shown that an especially convenient spoon is obtained, which does not have sharp edges which will be in contact with the user's lips during use.

Moreover, the double curvatured form contributes to form the bowl with a cavity, making it especially suitable for containing liquid products. Liquid products will mainly be contained in the part of the spoon portion adjacent to the handle portion. One can say that the connection portion more or less would constitute a part of the bowl portion of the spoon.

According to a further embodiment, the spoon is peculiar in that said vertex is positioned in the connecting portion.

When the vertex is arranged in the connecting portion, the cooperation between the longitudinal handle score and the bowl scores contributes to the formation of the cavity, making the spoon especially suitable to contain liquid products.

According to a further embodiment, the spoon is peculiar in that said planar blank further includes a longitudinal bowl score extending from said vertex along said longitudinal axis towards said rear lateral edge as a continuation of said longitudinal handle score.

When a longitudinal bowl score is provided in extension of the longitudinal handle score, it has shown that the formation of the cavity in the bowl portion becomes even more markedly. The cavity is well-defined having the deepest point arranged at the vertex. Hereby, it becomes possible to have a precise definition of the bowl portion having a deepest portion of the cavity in a point which is desired according to the intended use.

According to a further embodiment, the spoon is peculiar in that said planar blank is made of paperboard sheet, preferably including a coating of a moisture barrier material.

Hereby a spoon is provided which is environmentally friendly. Furthermore, the spoon may be manufactured at traditional plants used for paper-making of different products.

The quality of the paperboard sheet used will depend on the intended use.

The paperboard sheet used may include paperboard stock greater than 300 μm thick, preferably in the range of 500-600 μm.

The grammage may be in the range 230-380 g/m² for the paperboard.

In case the planar blank is provided with a coating, such coating may be chosen among coatings which are commonly used and approved in connection with food. An example is PE (polyethylene).

In general, the folding spoon according to the present invention has the advantage that it can be manufactured as a one-piece blank, which is inexpensive to manufacture.

The formation of the spoon from the one-piece blank does not require several manipulative steps, which could make it difficult for some persons to be able to use this type of spoon.

The potential user of the spoon will easily understand the proper method of formation of the spoon. The only requirement for formation of the spoon after having unfolded the folded spoon is to exert a pressure on the side edges of the handle portion. Hereby, the forces in combination with the scores and folding lines will result in that the spoon is properly formed.

When the spoon is formed, the connecting portions joining of the handle portion and the bowl portion will not have any weak area. Accordingly, there is no risk that the bowl portion and the handle portion will pivot unintentionally when used.

According to an embodiment, the bowl portion is, at the rear lateral edge, provided with a number of slits, thereby establishing fork branches between the slits. Such cutlery can be denoted as a fork and will be suitable e.g. for noodles.

In general, the planar blank used for manufacturing of the folding spoon may be treated in a punching station for punching and embossing the planar blanks from a paperboard sheet.

The paperboard sheet may be made partly or totally of material being thermoformable. Hereby it is possible, during the punching operation, to effect a thermoforming of the bowl portion and thereby provide a cavity having any desired form. In the same way, it is also possible to effect a thermoforming of the handle portion and thereby increasing the strength. Thermoforming may also be used to obtain spatial forms desired for the design of the folding spoon.

The thermoformed folding spoon will also be manufactured from a planar blank. The spoon will be manufactured with a first and second lateral score and a retainer flap, making it possible to fold the spoon and to maintain the spoon in a folded state.

According to a further embodiment, the method is peculiar in that, in said punching step, the number of said planar blanks is connected through a first retaining strip at the rear lateral edge and through the second retaining strip at the front lateral edge.

With this method, the planar blanks are provided in any number in a sheet which could have a desired form. The planar blanks are connected to the retaining strips at the rear end front lateral edges. Hereby it is possible in a convenient way to convey the planar blanks to the folding and cutting stations in more efficient way than will be possible with individual planar blanks.

According to a further embodiment, the method is peculiar in choosing said sheet either as a roll or as sheets from a stack of sheets which are continuously conveyed by the conveyor.

The material used for the sheet may be a roll. Hereby the sheet will have an endless form, as rolls could be provided with sheet material in lengths being several hundred metres long.

Alternatively, the sheets are individual sheets and provided in a stack of sheets.

Each sheet will have the planar blanks arranged side by side, and marginal side edges of such sheet will constitute the first and second retaining strips.

According to a further embodiment, the apparatus is peculiar in that said apparatus comprises a first and a second cutting station and that the folding station is arranged between said first and second cutting station.

When the first cutting station is arranged before the folding station, it is possible to provide the planar blanks in a condition where they are only attached to one of the retaining strips. Hereby, the distal ends of the planar blanks opposite to the retaining strips attaching the planar blanks can be folded individually.

Furthermore, the cutting in the first cutting station ensures that the rear lateral edges are free and thereby it is possible, when folding the spoon, to arrange the retainer flap behind the edge area adjacent to said rear lateral edge of the spoon.

After having established the different foldings in the folding station, it is possible to establish the cutting in the second cutting station and thereby provide individual spoons in folded and retained state and which are ready to be packed or to be distributed in bulk.

According to a further embodiment, the apparatus is peculiar in that said conveyor comprises endless belts which cooperate for conveying the planar blanks in a squeezed state between opposite arranged, endless belts and support element for supporting the planar blanks and the retaining strips in the folding and cutting stations.

When using endless belts it is possible, in a technical, simple way, to convey and squeeze the planar blanks. The use of friction belt is well-known and may easily be adapted in an apparatus according to the present invention.

The sheets will be continuously conveyed through the apparatus by the movement of the belts. Belts will be cooperating and comprise a set of supporting belts on which the sheet is resting, and one or more belts which is provided on the other side of the sheet and squeezes the sheet against the supporting belts.

The punching station may comprise a rotating punching and embossing tool, whereby the process could be established continuously. Alternatively, it is possible to have the process effected by stepwise conveying of the sheets.

The belts guide the sheet through the cutting station, which may comprise a rotating knife or a fixed knife which is used for the cutting actions.

During the folding, the sheet will be maintained in a transport plane, which normally is a horizontal plane.

Belt may be used for effecting the folding. Such belt would have an orientation out of the transport plane in order to effect the folding action.

A folding guide may be provided in order to assist in the folding around the first lateral handle score. Hereby it is ensured that the spoon will be folded correctly along the first lateral handle score while holding the other parts of the spoon in the horizontal position. The folding is preferably effected through 90° . After this, the folding guide is removed, and the spoon is folded through further 90° for a total folding of 180° , whereby the handle portion and bowl portion are superimposed.

The apparatus comprises a further set of belts, which can come into contact with the folded part of the spoon and fold these downwardly through an angle which is preferably 90° . Hereby, the retainer flap will still be positioned horizontally over the bowl portion. The further set of belts will then fold the spoon superposed portions back to a horizontal position while maintaining the spoon in folded state. Hereby, the retainer flap is placed on the outer side behind the edge area adjacent to the rear lateral edge of the spoon.

Even though it is preferred to use belts for guiding and folding the spoon, it is also possible to use guide rails. However, guide rails will be associated with friction. Therefore, the endless belts are preferred.

### DESCRIPTION OF THE DRAWING

The invention will be described with reference to the accompanying drawing, where each reference number refers to identical or functionally-similar elements throughout separate figures and where

FIG. 1 illustrates different views of a first embodiment for a folding spoon according to the present invention,

FIG. 2 illustrates views corresponding to FIG. 1 of a further embodiment for a folding spoon according to the present invention,

FIG. 3 illustrates views corresponding to FIG. 1 of a further embodiment for a folding spoon according to the present invention,

FIG. 4 illustrates views corresponding to FIG. 1 of a further embodiment for a folding spoon according to the present invention,

FIG. 5 illustrates views corresponding to FIG. 1 of a further embodiment for a folding spoon according to the present invention,

FIG. 6 illustrates a further embodiment of a folding spoon provided with slits in order to have a fork-like cutlery,

FIG. 7 illustrates different steps in the method of manufacturing the folding spoon,

FIG. 8 illustrates a partial view of a part of an apparatus according to the present invention,

FIG. 9 illustrates a partial view of a first cutting station of an apparatus according to the present invention,

FIG. 10 illustrates a partial view of a first part of a folding station in an apparatus according to the present invention,

FIG. 11 illustrates a partial view of a further part of the folding station in an apparatus according to the present invention, and

FIG. 12 illustrates a partial view of a second cutting station in an apparatus according to the present invention.

### DETAILED DESCRIPTION OF THE INVENTION

In the following text, the invention will be described in connection with the figures. Different parts and positions seen in the figures will be numbered with the same number in the different figures. Not all parts and positions indicated at a specific figure will necessarily be discussed together with such figure.

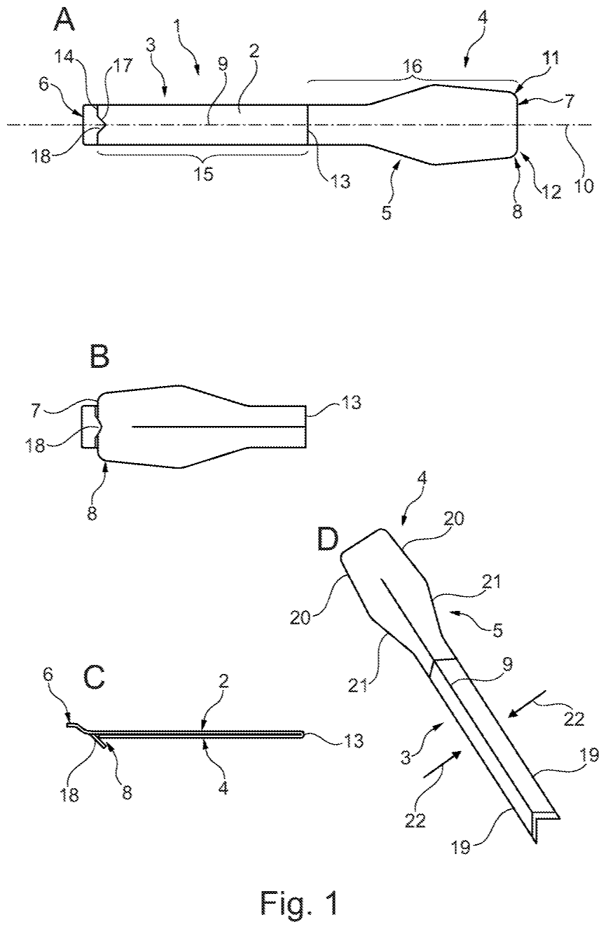

In FIG. 1-5, different views of a folded spoon 1 are illustrated.

View A illustrates a planar blank 2. View B illustrates a top view of the folding spoon in folded condition. View C illustrates a side view of the folding spoon in folded position. View D illustrates the folding spoon in unfolded state, ready to be used.

The planar blank comprises a handle portion 3 and a bowl portion 4 and a connecting portion 5 arranged between the handle portion 3 and the bowl portion 4. The planar blank has a front lateral edge 6 and a rear lateral edge 7. At the rear lateral edge 7, an edge area 8 is provided. The planar blank comprises a longitudinal handle score 9 extending from the front lateral edge 6 towards the rear lateral edge 7.

The planar blank has a longitudinal axis 10 dividing said planar blank into two general, symmetric halves 11, 12. The longitudinal handle score 9 is coinciding with the longitudinal axis 10.

The planar blank comprises a first lateral score 13. The first lateral score 13 is arranged in the handle portion 2. It is placed closer to the rear lateral edge 7 than to the front lateral edge 6.

The planar blank comprises a second lateral score 14 arranged in the handle portion 2 in a distance 15 from the first lateral score 13. The distance 15 between the first lateral score 13 and the second lateral score 14 correspond to a distance 16 between the first lateral score 13 and the rear lateral edge 7.

A cut out 17 extends from said second lateral score 14 towards the rear lateral edge 7 and back to the second lateral score 14. In the illustrated form, the cut out is provided as two linear cuts ending in a common point at the longitudinal axis 10. The cut out defines a retainer flap 18.

As seen in the views B and C, the retainer flap 18 will be placed behind the edge area 8 adjacent to the rear lateral edge 7 when the spoon is in the folded condition folded along the first lateral score 13.

View D illustrates the spoon in unfolded state. The spoon has opposing side edges 19 at the handle portion 3 and opposing side edges 20 at the bowl portion 4. Opposing side edges 21 at the connection portion 5 connect the side edges 19 and 20.

In view D, arrows 22 indicate forces exerted on the side edges 19 of the handle portion 3. These forces are exerted by the user's fingers and will be sufficient for effecting a folding of the spoon along the longitudinal handle score 9 as illustrated. Hereby, the spoon is ready for use, and due to the folding, it will have a stable condition without risk that the bowl portion and handle portion will pivot in relation to each other during use.

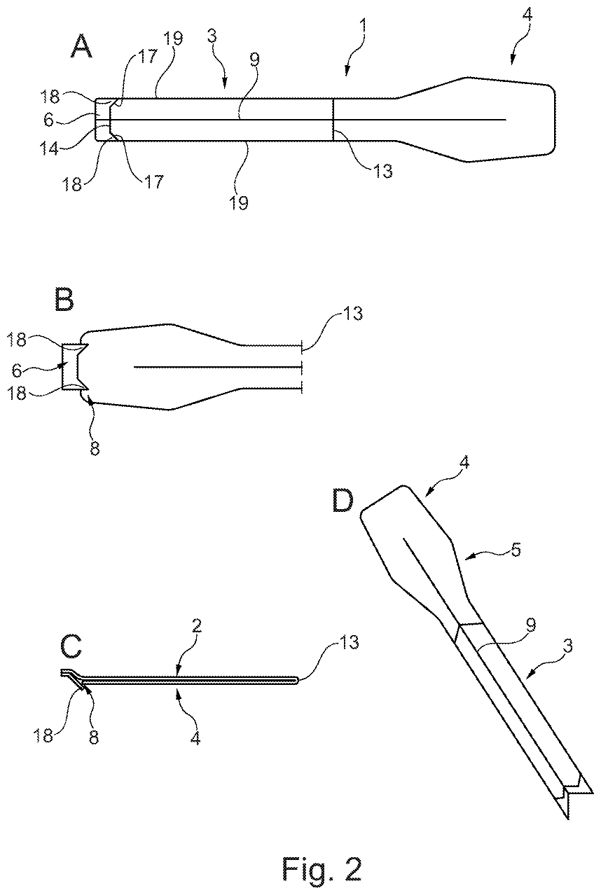

FIG. 2 corresponds to FIG. 1. However, here it is seen that cut outs 17 are arranged at each side of the handle portion and extend to the side edges 21 of the handle portion 3. Hereby, two retainer flaps 18 are provided.

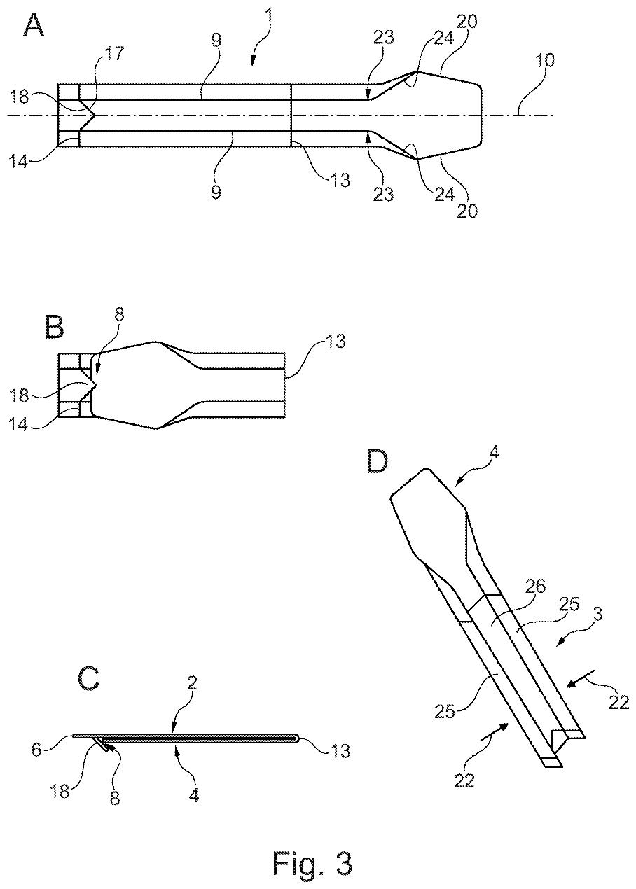

FIG. 3 illustrates a further embodiment in which two longitudinal handle scores 9 are provided. The two longitudinal handle scores 9 are provided symmetrically in relation to the longitudinal axis 10.

The longitudinal handle scores ends at point 23. From each point 23, a bowl score 24 extends towards the rear lateral edge 7 and ends at the side edges 20 of the bowl portion 4.

As seen in view D, the unfolded spoon will be provided with two side walls 25 connecting a bottom 26 in the handle portion 3. In order to fold up the wall parts 25, forces 22 are needed in the same way as the forces exerted in the above explained embodiments.

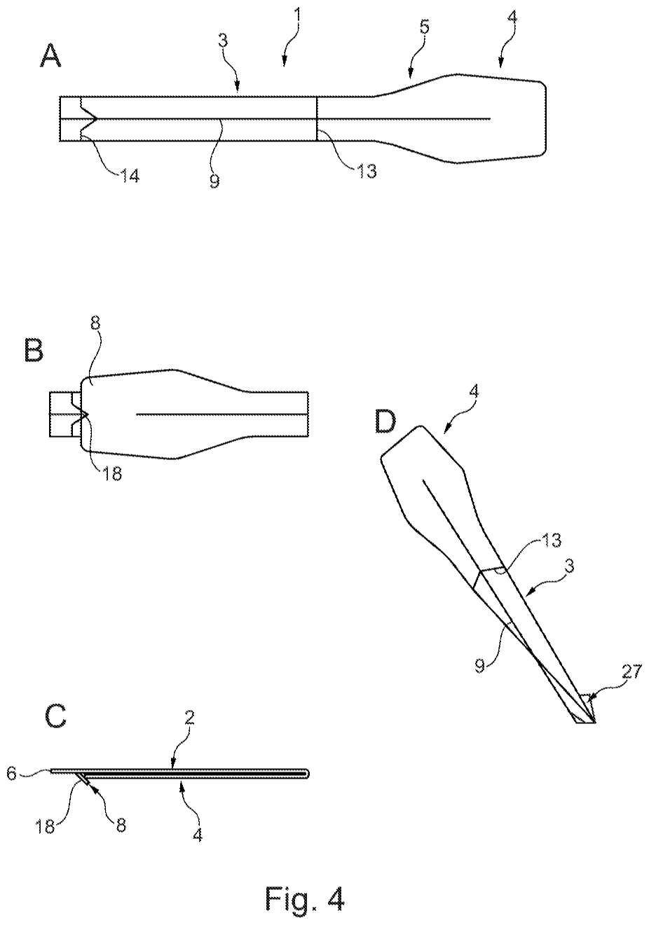

FIG. 4 illustrates a further embodiment corresponding to the embodiment illustrated in FIG. 1. View D illustrates the unfolded state of the spoon. Here it is seen that a folded portion 27 is provided as the edge area at the front lateral edge is folded along the second lateral handle score 14. Hereby the handle portion will maintain its V-shape, without the need of exerting forces on the side edges of the handle portion. The folded portion 27 may be provided with glue in order to keep the folded portion 27 attached to the remainder of the handle portion 3.

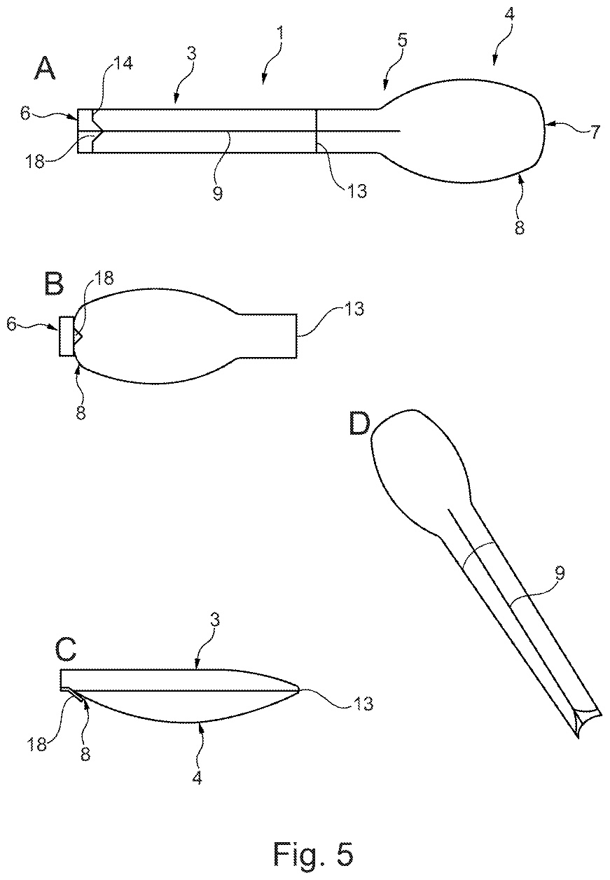

FIG. 5 illustrates a folding spoon in which the bowl portion 4 and handle portion 3 are thermoformed to a spatial form when providing the planar blank with score lines.

View C illustrates clearly that the bowl portion 4 and handle portion 3 have a curved form. A longitudinal handle score 9 is provided. However, this is provided in order to amend the mutual position of the two symmetrical halves of the handle portion, when the spoon is used. It might be possible to provide the spoon without the longitudinal handle score if the thermoformed handle in itself is sufficiently stiff for use.

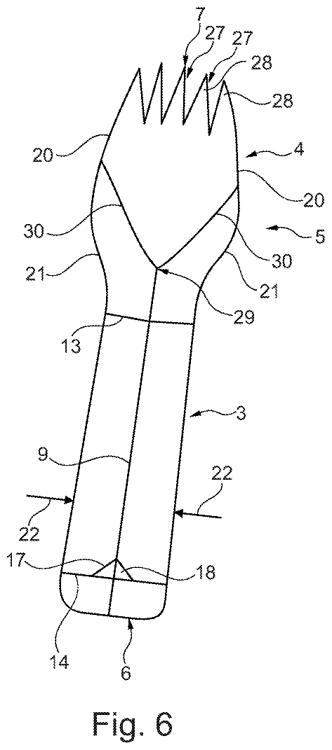

FIG. 6 illustrates a further embodiment in which the bowl portion 4 is provided with slits 27. Hereby, fork branches 28 are formed. Hereby, a cutlery is established which could also be noted as fork.

FIG. 6 illustrates that the longitudinal handle score 9 ends in a vertex 29. From said vertex 29 two bowl scores 30 extend towards the rear lateral edge 7 and extend to the side edges 20 of the bowl portion.

Even though the embodiment with the vertex 29 and the bowl scores 30 are only illustrated in connection with the embodiment of FIG. 6, then it is understood that a corresponding use of scores will also apply in embodiments according to FIGS. 1, 2 and 4.

The use of the vertex 29, at which the handle score 9 and the bowl scores 30 meets, will make it possible to provide a hollowed form of the bowl portion when applying the forces 22 on the side edges of the handle portion 3. The bowl portion 4 will be drawn upwardly in relation to a straight line containing the longitudinal handle score when the forces 22 are applied on the handle portion.

In FIG. 6 it is illustrated that the side edges 21 of the connecting portion 5 has a double curvatured form. A corresponding form of the side edges 21 of the connecting portion 5 may also be used in embodiments according to FIGS. 1, 2 and 4.

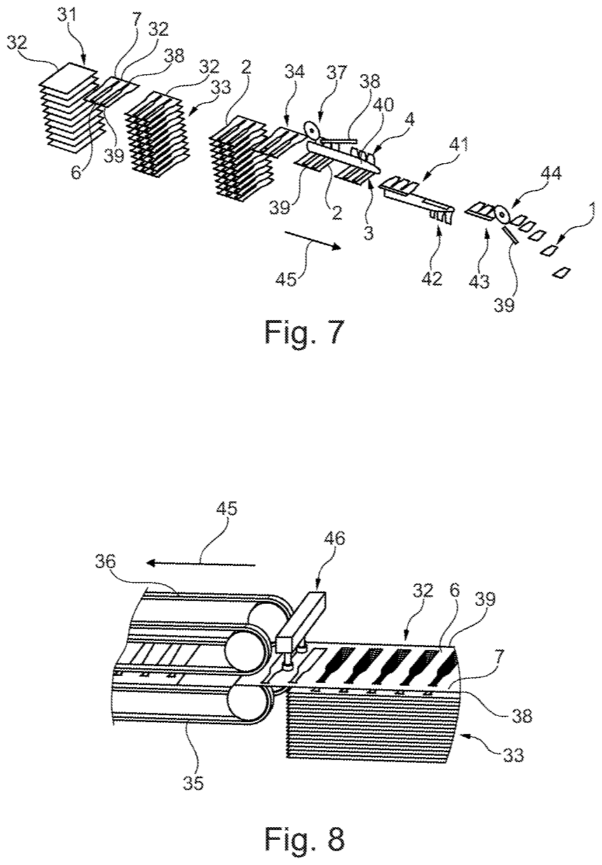

FIG. 7 illustrates the different steps of the method for manufacturing the folding spoon 1 in a folded state. In FIG. 7 is illustrated a stack 31 of paperboard sheets 32. After punching and embossing the sheets 32 they are provided as a stack 33 of the punched and embossed sheets 32. This stack 33 is transferred as indicated at 34 to conveying equipment which is illustrated in FIGS. 8-12. When conveying the sheets, they will be provided in a pinched condition between endless belts 35,36 (see FIG. 8).

In the sheets 32, the planar blanks 2 are connected through the first retaining strip 38 at the rear lateral edge 7 of the planar blanks 2 and a second retaining strip 39 at the front lateral edge 6 of the planar blanks 2.

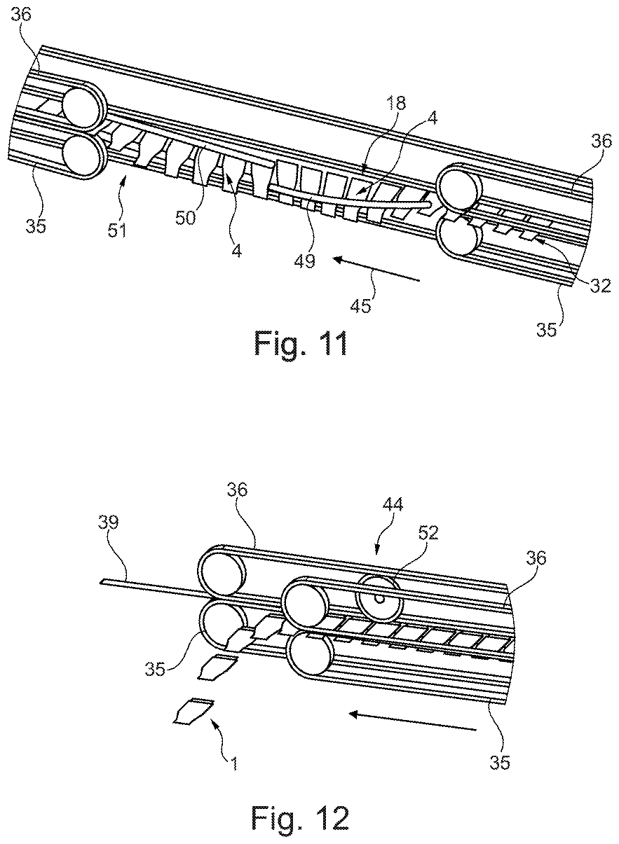

In a first cutting station 37, the first retaining strip 38 is cut off, thereby leaving the rear lateral edge 7 free, whereas the front lateral edge 6 is still connected to the second retaining strip 39. The sheet is conveyed to a folding station. A folding of the bowl portion 4 in relation to the handle portion 3 is effected around a folding guide 40 by means of belts illustrated in FIGS. 10 and 11.

Hereafter, the bowl portion and the handle portion are provided in a superimposed state as illustrated at 41. Hereafter, further folding is effected, whereby the superimposed portions are folded downwardly as indicated by 42. A part of the handle portion and the second retaining strip 39 are maintained in the original plane, which could be denoted as a transport plane, and which will normally be horizontal. As indicated at 43, the superimposed portions are folded back to the transport plane. Hereby the retainer flap 18 is positioned behind the edge area 8. Hereafter, a further cutting station 44 is provided for cutting off the second retaining strip 39. Hereby, the folding spoons 1 are leaving the equipment as individually items in a folded and retained position.

In FIG. 7, arrow 45 indicates the transport direction of the sheets through the method steps and accordingly through the apparatus used for effecting the method.

FIG. 8 illustrates details of the apparatus according to the invention used for the manufacture of the folding spoon 1. Also here, the arrow 45 indicates the transport direction of the sheets through the apparatus.

FIG. 8 illustrates endless belts 35,36 which are used for pinching the sheet 32 and conveying the sheet 32 from the stack 33 through the apparatus. FIG. 8 illustrates a vacuum unit 46 used for transferring the uppermost sheet 32 in the stack 33 into a nip between the endless belts 35,36.

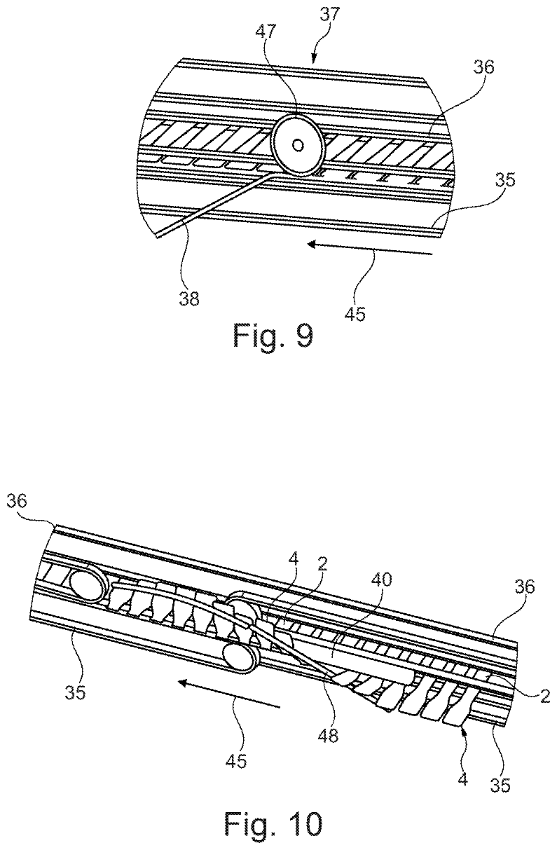

FIG. 9 illustrates the first cutting station 37 for cutting the first retaining strip 38 out of the sheets 32. A rotating knife 47 is used. The knife cooperates with fixed cutting bar (not illustrated).

FIG. 10 illustrates a folding station. A belt 48 is used for folding the bowl portion around a folding guide 40 when advancing the sheets according to the arrow 45. Instead of a belt 48, a guiding rail may be used. The bowl portion 4 is folded through 180 degrees to be placed upon the handle portion 3.

FIG. 11 illustrates a second part of the folding station, where the superimposed bowl portions and handle portions are folded 90° downwardly. As illustrated, the retainer flaps 18 remain in the transport plane. A further belt 50 is used for folding the superimposed portions upwardly back into the transport plane as illustrated at 51. Hereby, the retainer flaps 18 are placed behind the edge area 8 of the spoon portion 4.

FIG. 12 illustrates the second cutting station 44 in which a rotating knife 52 is used for cutting free the second retaining strip 39. Hereby, the folding spoons 1 can freely and individually be transferred to further prosecution in a folded and retained state.

1. A folding spoon comprising:
a planar blank having along a longitudinal axis, a handle portion with a front lateral edge, and a bowl portion with a rear lateral edge; and
a plurality of scores disposed on said planar blank including
a longitudinal handle folding line extending from said front lateral edge along said longitudinal axis towards a rear lateral edge opposite said front lateral edge and terminating in the bowl portion, or
two longitudinal handle folding lines provided on said planar blank symmetrically in relation to the longitudinal axis;
wherein the handle portion includes a first lateral folding line in a position closer to said rear lateral edge than to said front lateral edge and extending transverse to said longitudinal axis, and
further including a cut out forming a retainer flap arranged to be placed behind an edge area at said rear lateral edge when the spoon is in folded condition, being folded along said first lateral folding line.

2. The folding spoon of claim 1, wherein the folding spoon further includes
a second lateral folding line arranged in said handle portion between said first lateral folding line and said front lateral edge in a distance from said first lateral folding line corresponding to the distance between said first lateral folding line and said rear lateral edge and extending transversal to said longitudinal axis.

3. The folding spoon of claim 2, wherein the cut out extends from said second lateral folding line towards said rear lateral edge and back to said second lateral folding line.

4. The folding spoon of claim 1, wherein that the at least one longitudinal handle folding line extends to a bowl folding line, the bowl folding line extending towards the rear lateral edge and ends at the side edge of the bowl portion.

5. The folding spoon of claim 1, wherein said handle portion has a width which is smaller than the width of the bowl portion and that the bowl portion is connected to the handle portion via a connecting portion having double curvatured side edges connecting outer side edges of the handle portion and the bowl portion.

6. The folding spoon of claim 5, wherein said vertex is positioned in the connecting portion.

7. The folding spoon of claim 1, wherein said planar blank consists essentially of paperboard sheet.

8. The folding spoon of claim 1, wherein said planar blank consists essentially of cardboard or plastic.

9. The folding spoon of claim 1, wherein said planar blank consists essentially of paperboard or cardboard, and wherein the thickness of the planar blank is greater than 300 μm.

10. The folding spoon of claim 1, wherein the cut out is a slit.

11. A method for manufacturing a folding spoon in a folded state, the method comprises the steps of:
punching and embossing a sheet for establishing a number of said planar blanks which are arranged side by side and are connected through a first retaining strip and a second retaining strip at the front lateral edge and the rear lateral edge,
transferring said punched sheet to a conveyor,
conveying, in the conveyor, the punched sheet in a state being pinched in a transport plane between upper and lower pinching means to a first cutting station,
cutting off, in the first cutting station, the first retaining strip thereby leaving the planar blank only connected through the second retaining strip,
conveying, in the conveyor, the connected planar blank in the pinched state to a folding station while removing the first retaining strip,
folding, in the folding station, the planar blank along a first lateral score while pinching a part of the planar blank thereby bringing a handle portion and a bowl portion in superimposed position being squeezed against each other in the transport plane,
folding, in the folding station, the superimposed portions of the now folded blank along a second lateral score thereby a retainer flap in the transport plane as the edge area between the second lateral score and the front lateral edge,
folding, in the folding station, a portion of the superimposed portions of the now folded blank along the second lateral score back to the transport plane and thereby placing the retainer flap behind the edge area at said rear lateral edge when the spoon is in folded condition,
conveying, in the conveyor, the spoon in folded and retained state to a second cutting station, and
cutting off, in the second cutting station, the second retaining strip thereby providing folded spoons in the folded and retained state.

12. The method according to claim 11, characterised in that in said punching step the number of said planar blanks is connected through a first retaining strip at the rear lateral edge and through the second retaining strip at the front lateral edge.

13. The method according to claim 11, further including choosing said sheet either as a roll or as sheets from a stack of sheets which are continuously conveyed by the conveyor.

14. Apparatus for manufacturing a folding spoon comprising:
a punching station configured for punching and embossing planer blanks out from a sheet,
at least one cutting station configured for cutting the planar blanks free from retaining strips connecting the planar blanks,
a conveyor configured for conveying the planar blanks through the different stations, and
a folding station configured for folding the planar blanks into the folded spoons in a folded and retained state.

15. The apparatus according to claim 14, further including a first and a second cutting station and that the folding station is arranged between said first and second cutting station.

16. The apparatus according to claim 14, characterised in that said conveyor comprises endless belts configured to convey, the planar blanks in a squeezed state between opposite arranged endless belts and support element for supporting the planar blanks and the retaining strips in the folding and cutting stations.

17. The folding spoon of claim 9, wherein the thickness of the planar blank is in the range of 500-600 μm.

18. The folding spoon of claim 7, wherein the planar blank further includes a moisture barrier coating.

19. The folding spoon of claim 1, wherein the spoon further including a second cut out forming a second retainer flap arranged to be placed behind an edge area at said rear lateral edge when the spoon is in folded condition, being folded along said first lateral folding line.

20. The folding spoon of claim 18, wherein the cut outs are arranged at each side of the handle portion and extend to the side edges of the handle portion.

21. The method of claim 12, further including choosing said sheet either as a roll or as sheets from a stack of sheets which are continuously conveyed by the conveyor.

22. The apparatus of claim 15, characterised in that said conveyor comprises endless belts configured to convey the planar blanks in a squeezed state between opposite arranged endless belts and support element for supporting the planar blanks and the retaining strips in the folding and cutting stations.
